(19) United States
(12) Patent Application Publication
(10) Pub. No.: US 2007/0156534 A1
(43) Pub. Date: Jul. 5, 2007

(54) Content file downloading over a network with usage rights

(75) Inventors: Ofer Lerner, Tel-Aviv (IL); Addie Ben-Yehuda, Tel-Aviv (IL)

Correspondence Address: Martin D. Moynihan;PRTSI, Inc., P.O. Box 16446, Arlington, VA, 22215, US

(73) Assignee: HighTech Systems Ltd., Tel-Aviv (IL)

(21) Appl. No.: 11/715,877

(22) Filed: Mar. 9, 2007

Related U.S. Application Data
(63) Continuation-in-part of application No. 10/876,679, filed on Jun. 28, 2004.

(51) Int. Cl. G06Q 30/00

(52) U.S. Cl. 705/14

(57) ABSTRACT

A method of distributing content over a network comprising: providing a content file comprising media content from a content source; providing an advertisement file comprising advertisement content from an advertisement provider, combining said content file and said advertisement file into a combined file in playable format, configured such that a location within said combined file of said advertisement content is substantially indistinguishable without playing said combined file; receiving requests from users for said content; debiting said advertisement provider with an advertisement fee; crediting said content source with said advertisement fee; and downloading said combined file to requesting users for playing thereof. The method allows a copyright holder to be paid for the download whilst the download remains free to the end user. The method may for example be applied to file sharing systems or to websites wishing to offer a ‘freebie’ to induce more site visiting.

### RELATED APPLICATIONS

The present Application is a continuation-in-part of U.S. patent application Ser. No. 10/876,679, filed Jun. 28, 2004, the contents of which are hereby incorporated by reference.

### FIELD AND BACKGROUND OF THE INVENTION

The present invention relates to content file downloading over a network with usage rights and, more particularly, but not exclusively to a method and apparatus that allows for commercial funding of the usage rights so that content usage remains free to the end user.

The Internet is a very efficient and widely used medium for distribution of content such as video, music and the like since distribution costs are negligible. There is no need to pay for transport or for wholesale or retail distributors. All that is needed is capacity at a server and the content itself.

A significant problem today with the Internet is illegal downloading of copyright protected content on the web, and file sharing of that content, without payment for usage. In the last ten years the music industry worldwide has lost billions of dollars on illegal downloading and subsequent use of its property. People have been more than willing to risk lawsuits rather than pay for music and like content on-line. The technological opportunities that have been available to us for the last ten years have changed the way people are exposed to, listen to and purchase content, and by doing so, have made it nearly impossible to monitor and change the way the content is consumed these days. The music industry in particular been looking for ways to stop copyright infringement by users, and to incorporate new methods of payment for use and purchase of content over the web. Up until now they have been partly successful. On-line shops selling music have reported sales of tens of millions over a period of 6 months, but latest research has also shown that old habits die hard. Illegal music downloading has not stopped. On the contrary, it has even increased in the last few months, following the US Supreme Court ruling against the RIAA request to expose the names and identities of end-users downloading music illegally on the net.

In a different field, that of advertising, there has been a shift in recent years, towards more inventive and content-based advertising ideas, since old methods are no longer as effective as they used to be. Audiences have shifted from the television and turned to other media, for example the Internet and cellular media, lowering the value of Television advertising. The ever-elusive 12-35 target audience is no longer found in mass through the television. Moreover, Internet advertising costs are significantly lower than television advertising, despite the fact that the internet has shown much more accurate reaction to publicity campaigns and can give the advertiser a much more in-depth analysis of the target market the advertiser is looking for.

There is thus a widely recognized need for, and it would be highly advantageous to have, a content distribution system that takes advantage of the willingness of users to download content over the Internet and does not deny the rights holders of the content of their revenue.

### SUMMARY OF THE INVENTION

According to one aspect of the present invention there is provided a method of distributing content over a network comprising:

providing a content file comprising media content from a content source;

providing an advertisement file comprising advertisement content from an advertisement provider,

combining the content file and the advertisement file into a combined file in playable format, configured such that a location within the combined file of the advertisement content is substantially indistinguishable without playing the combined file;

receiving requests from users for the content;

debiting the advertisement provider with an advertisement fee;

crediting the content source with the advertisement fee; and

downloading the combined file to requesting users for playing thereof.

Preferably, the debiting and the crediting are carried out per user request.

Alternatively or additionally, the debiting and the crediting are carried out based on a global estimation of user requests.

The method may comprise screening out repeated requests from same network nodes.

The method may comprise compiling statistics of users requesting the content for providing to the advertising source.

The method may comprise providing multiple content files, for example in the context of a file sharing arrangement.

Preferably, the media content is any one of a group comprising: text, music, speech, combined speech and music, video, and a computer game.

The method may comprise having a plurality of advertisement content items from a single advertisement provider, and using a predetermined algorithm to place different ones of the advertisement content items with the media content to form corresponding combined files.

The method may comprise having a plurality of media items each requiring a different fee, and having a plurality of advertisement content items, and continuing to combine further advertisement content items with each respective media items to construct a corresponding combined file until a respective fee is covered.

The method may comprise providing a plurality of advertisement content items from a plurality of advertisement providers, using a predetermined algorithm to place different ones of the advertisement content items from different advertisement providers to form corresponding combined files and debiting the respective advertisement provider.

The method may comprise providing a content item combined with a plurality of advertisement items wherein only a fractional group of the advertisement items are active during a content playing event and the group of active advertisement items changes automatically at random or after a pre-defined number of content playing events.

The method may comprise promoting content distribution by the publisher providing content free of charge, by the advertiser by not being paid for downloaded advertisements, providing advertisement free of charge or by the distributor providing content without combined advertisement.

The network may be the Internet including broadband Internet, Interactive TV and the like or for example a cellular network.

According to a second aspect of the present invention there is provided a computer readable medium for use with a computer network for distributing content over the network, the distributing comprising:

providing a content file comprising media content from a content source.

providing an advertisement file comprising advertisement content from an advertisement provider,

combining the content file and the advertisement file into a combined file in playable format, configured such that a location within the combined file of the advertisement content is substantially indistinguishable without playing the combined file;

receiving requests from users for the content;

debiting the advertisement provider with an advertisement fee;

crediting the content source with the advertisement fee; and

downloading the combined file to requesting users for playing thereof.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified diagram showing a system for combining of content and advertising and the distribution of the resulting combined file to a requesting user, according to a first preferred embodiment of the present invention;

FIG. 2 is a schematic diagram illustrating a variation of the embodiment of FIG. 1 using a single combining server to provide ready combined files to one or more distribution servers;

FIG. 3 is a schematic diagram illustrating the combining of a media content file and an advertising file to form a combined file with advertising content at an unpredictable location in the file, according to a preferred embodiment of the present invention;

FIG. 4 is a simplified flow chart illustrating a method of providing media and advertising content, combining them, passing payment from an advertiser to the media content provider and providing the combined file to the requesting user, according to a preferred embodiment of the present invention;

FIG. 5 is a variation of the flow chart of FIG. 4 in which there are m media content items and n advertising content items;

FIG. 6 is a simplified flow chart illustrating the matching of advertisements to media content based on projected target audiences;

FIG. 7 is a simplified flow chart illustrating a method of preventing a media source from generating spurious download requests to obtain additional advertising fees;

FIG. 8 is a simplified flow chart illustrating a method of combining a given media file with more than one advertisement until a copyright fee of a given size is paid; and

FIG. 9 is a simplified schematic diagram showing an application of the present embodiments as a back office to a file sharing system.

### DESCRIPTION OF THE PREFERRED EMBODIMENTS

The present embodiments comprise a method of embedding advertising content into a media file prior to distribution, passing an advertising fee from the advertisement provider to the content provider or content source, and distributing the media file with the embedded advertisement to requesting users free of charge. Despite the distribution being free of charge to the end user, the copyright and other usage fees have been paid for by the advertising. Such a distribution system is equally applicable to file sharing networks and to websites that wish to offer “freebies” to encourage site hits. The distribution system may be any kind of interactive media, and may for example be based upon the Internet, interactive TV, other broadband services or on any of the various cellular networking solutions.

The principles and operation of a media content distribution system according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

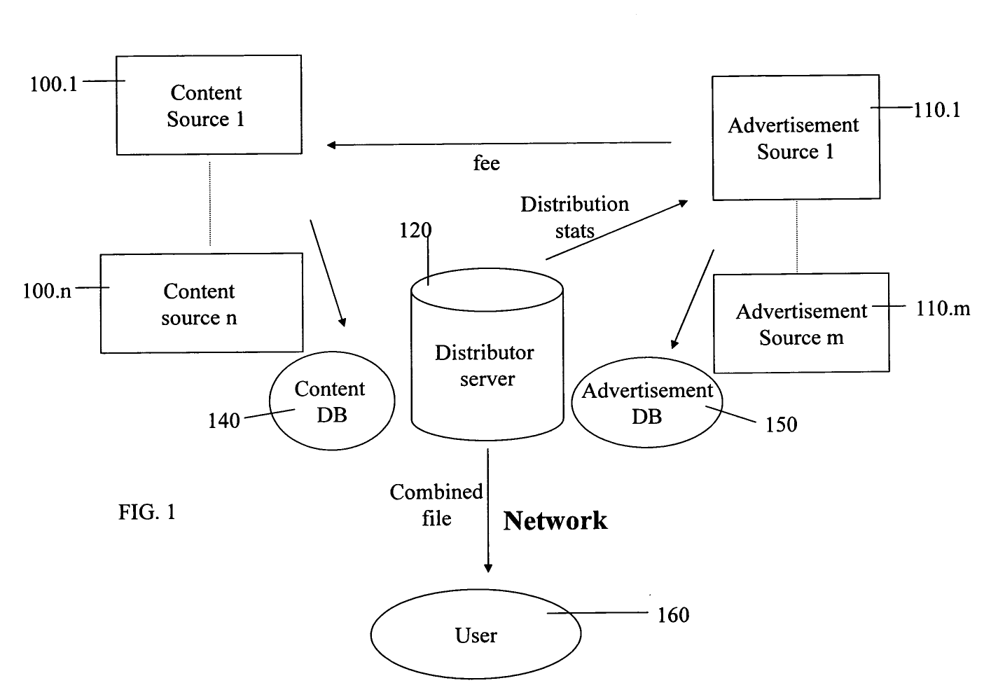

Reference is now made to FIG. 1, which is a simplified diagram illustrating a server-based infrastructure configured for content distribution according to the preferred embodiments of the present invention. N content sources 100.1 . . . 100.n are sources of multimedia content. The content sources are entities that provide the content and own the distribution or reproduction rights, or operate on behalf of the rights holders. The content sources may be music companies, computer games providers, film companies and the like.

Likewise there are m advertising entities 110.1 . . . 110.m which produce advertising material for electronic distribution, and for the distribution of which the advertising entity is prepared to pay.

A distributor server 120 is located on a network. The distribution server 120 is typically a web site that wishes to offer content free of charge to browsers. The web site may be a site that distributes free music or games or the like, or a web site with a different purpose that wishes to use the content files as “freebies” to encourage high volume and return visits to the site. Distribution server 120 may alternatively be a node on a file sharing network or system.

Distribution server receives content from the content sources and advertising material from the advertising sources. The two types of material may be stored in separate databases, content database 140 and advertisement database 150. It will be appreciated that such separate databases are not always necessary, particularly in cases where a website offers a single item of media content. Conversely, the advertisement database may be external to the distribution database and located on a separate advertisement server.

In the embodiment of FIG. 1, the distribution database combines the advertising content with the multimedia content to generate a single high quality media file for downloading to the user. As will be explained in greater detail below, the location of the advertising material is unknown to the end user until he actually plays the file, ensuring that he hears the advertising material at least once.

Finally the combined file is downloaded to end user 160. Downloading is preferably carried out electronically via any suitable network, including the cellular telephony network and the Internet. Broadband communication networks are typically used for content downloading to keep downloading time low. Using broadband it may be hoped that a title downloading time does not exceed 1.5 minutes for a practical content size. Broadband also allows CD quality for the content. Typically the cellular network can download data files using WAP or GPRS. Network format is not limited to the above WAP or GPRS formats. Various existing data communication formats may be used by converting the content and advertisement combined file into a file structure compatible with the associated format. The Internet uses TCP/IP, FTP and like protocols. The delivery of the media and advertising content to the distribution server may be carried out online over a network or may be carried out in other ways, for example by the physical delivery of a CD Rom.

In a preferred embodiment, the downloading of the combined file triggers a debit to be made from the advertising entity 110 of an advertising fee and a credit of the same fee to the content provider 100. As will be explained in greater detail below, the triggering of the fee may be directly related to the download operation, or may be indirectly related thereto, based for example on usage statistics relating to the download.

Various measures may be employed in promoting the downloading of content or the downloading of content-related advertisements.

Users may be encouraged to download content by promotional measures applied by the distributor. The measures consist of but are not limited to: providing content free of advertisement for a restricted time or to users say drawn in a raffle. Promotions may be carried out for new content, or to boost sales of old content as preferred. In one embodiment, content without advertisement may be provided to the user for some form of virtual money payment. Alternatively content may be made available for free during selected hours during the day, a so-called happy hour.

Newly created content may be promoted by offering the content without advertisement, say to special clients such as long-standing and loyal users, frequent users and users introducing new customers. In addition, content may be provided free to users as consolation prizes and prizes may be distributed to users by advertisers to such customers. In order to retain anonymity with the system an advertiser may use email to send the prize, or may say use coupons for cellular use as the prizes, the latter being delivered to the cellular telephone downloading the content so that the prizes can be delivered without revealing to the advertiser anything more about the user than he knows already.

Users may be drawn in promotional raffles and given content free of advertisement, say on condition that users who enter the raffle but are not drawn are required to receive the content with advertising.

New content files, or other content it is desired to promote, may be promoted by providing them to the user for a limited time, free of advertisement, and some of the new content files may be promoted in this way more than other content files.

Promotional measures may likewise be directed at advertisers, and may comprise providing content free of charge in a second network when the content is purchased in a first network.

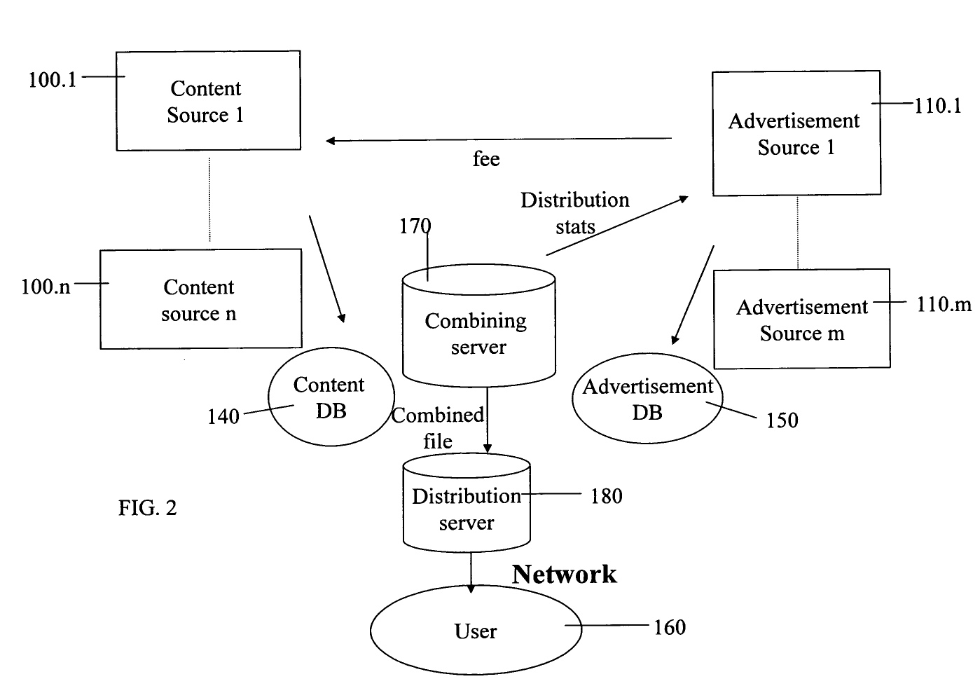

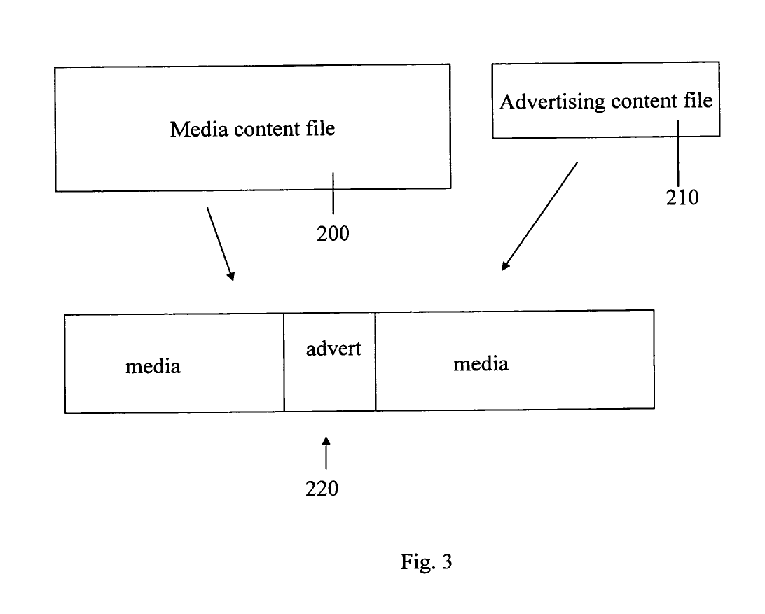

Reference is now made to FIG. 2, which shows an alternative embodiment of the system of FIG. 1. Parts that are the same as in previous figures are given the same reference numerals and are not referred to again except as necessary for understanding the present embodiment. In FIG. 2 the functions of file combining and file distribution are divided between two servers, a combining server 170 and a distribution server 180. The combining server actually combines the advertising and media files and makes the combined files available to one or more distribution servers as a ready made product for distribution. Thus the combining server may provide a catalog of media files available for distribution by individual websites. In this way the combining server may be set up to manage a file-sharing network. Each download of a file to an end user is preferably signaled to the combining server which then either directly or indirectly triggers the payment of the advertising fee. The fee which may be paid directly to the publisher or indirectly through the content provider. Reference is now made to FIG. 3, which is a simplified diagram illustrating a content file 200 and an advertisement file 210 as they might be provided by the content and advertisement providers respectively. A combined file 220 may be formed by taking the material of the advertisement file and splicing it into the content file. In the simplest embodiment the advertisement file is located at the start of the combined file but this is not preferred as it allows users to easily skip the advertisement. Preferably the advertisement file is located at a random location in the media. Again, in order to make the resulting file acceptable to users it is preferable that the location not be totally random but rather rely on natural breaks in the media material. Thus in one embodiment a random number may be produced indicating a position along the time axis of the file. Then the nearest natural break to the indicated position is selected for location of the advertisement. The natural break may be identified automatically by artificial intelligence or selected manually by an operator. Certain types of media are more suitable for artificial intelligence than others.

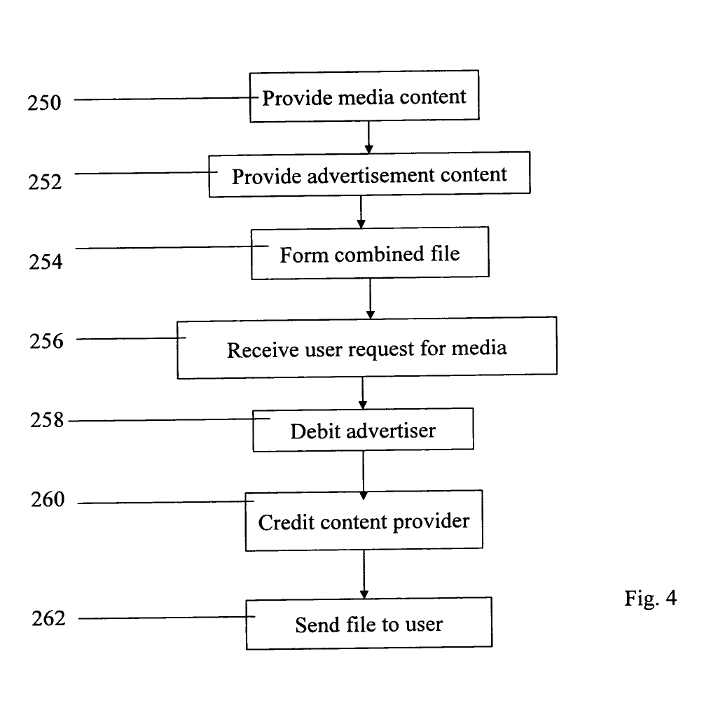

It is noted that the splicing into a position within the media is particularly appropriate for games. Game-play is not necessarily linear and there is no guarantee that any particular portion of the track may ever be reached. Thus in games it may be possible to locate several advertisements at several locations in the game-play. Reference is now made to FIG. 4, which is a simplified flow diagram illustrating a method of distributing content over a network according to a first preferred embodiment of the present invention. The method comprises stages as follows: First of all a stage 250 comprises providing a content file which includes media content and which comes from a content source. Secondly, in stage 252 there is provided an advertisement file comprising advertisement content from an advertisement provider.

Advertisements are generally associated with a company being advertised or with specific content or directed to a target audience.

Content, once purchased, tends to be kept for a considerable period of time, typically much longer than any individual advertising campaign. Advertisers may be enabled to selectively remove old advertisements of older non-relevant campaigns or update advertisements associated with long-standing campaigns. Content still being circulated can have updated advertisements. In one embodiment the content remains on-line and simply receives new advertisements. In another embodiment the advertisements time out in various ways, say after a given amount of time. Alternatively the advertisements may time out after a given number of viewings. A series of advertisements could be supplied with the content so that each advertisement is played a certain number of times and then another is played.

In stage 254 the two files are combined, as explained in respect of FIG. 3 above into a combined file. The combined file is preferably in a playable format, and is configured such that a location within the combined file of the advertisement content is substantially indistinguishable from the rest of the file until the combined file is actually played. That is to say the advert is simply spliced into the media content so that the result looks like a single continuous file.

A network node having access to the combined result above receives requests from users for download of the content in a stage 256. It is noted that the request need not be explicit. That is to say the content could automatically be provided to a user who attempts to open a given page on the website or who clicks a given graphic or the like. It is noted that the request stage need not be performed after the combining stage. In one embodiment, information is available on the user requesting the download and is used to select which advertisement to place in the combined file. Thus the combined file is only formed when the identity of the user is known. In another embodiment a range of advertisements are placed as alternatives into the same content item and the most appropriate combined file is then selected for the user upon making the request. A fraction of the embedded advertisements may be playing when content is being played, while other embedded advertisements may be inactive during a content playing event.

The actively playing advertisements may be automatically varied when a new content playing event begins, or may be selected according to the current user's membership of a target audience group. The user's group membership may be determined say based on content playing statistics. A user client for playing the content may gather the necessary statistics.

As a further alternative, a randomly changing played advertisement may be used.

In a stage 258 the advertisement provider is debited for an advertisement fee. As explained above, the debit may be explicitly related to the download request or the connection between the two may be statistical, as preferred.

The advertisement fee is then credited to the content source, as payment for usage rights to the media content. Thus the end user has purchased usage rights to the content that he downloads in stage 260.

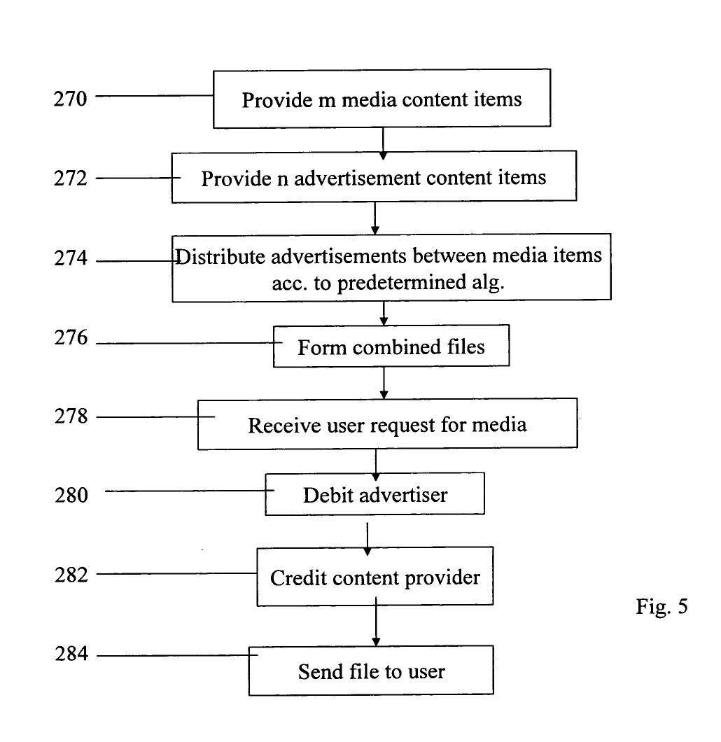

Reference is now made to FIG. 5, which is a simplified flow chart illustrating a modification of the method of FIG. 4 for the case of m media content items and n advertisement items. The flow is broadly the same as that shown in FIG. 3 and stages that are the same as those of FIG. 3 are not described again except as necessary for an understanding of the present embodiment. In FIG. 5, m media content items are provided in a first stage 270. In a stage 272, n advertisement items are provided.

In a stage 274, the advertisement items are distributed amongst the media items according to a predetermined algorithm. Numerous algorithms may be used, one of which has already been mentioned above, namely that the selection is based on user information of the requesting user. Another possibility is to randomly distribute adverts in accordance with proportions that have been ordered and/or paid for by the advertising sources.

The selection of multiple advertisement items for a particular content item may be modified randomly, say when more than a single relevant advertiser has an advertisement campaign going on. Particular advertisement files may be inserted into different content items when the different content items are closely related, say for example to ensure that advertisements are added to relevant content, thereby to better target audiences.

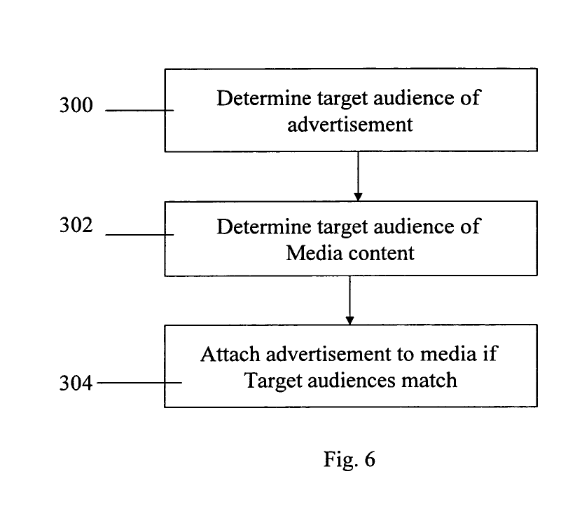

A third possibility is illustrated in FIG. 6, to which reference is now made. In the method of FIG. 6 a stage 300 involves categorizing advertisements in terms of a target audience. In stage 302 the media content is likewise categorized in terms of a target audience. Finally in stage 304, advertisements are attached to those media content items whose target audience matches that of the advertisement.

Returning to FIG. 5 and following the distribution of stage 274, combined files are formed in stage 276, as before. The user requests a download in stage 278, which may occur before or after the distribution and combining, as explained. The appropriate advertisement source is debited in stage 280, and the appropriate media source credited in stage 282 before the content is downloaded to the user in stage 284.

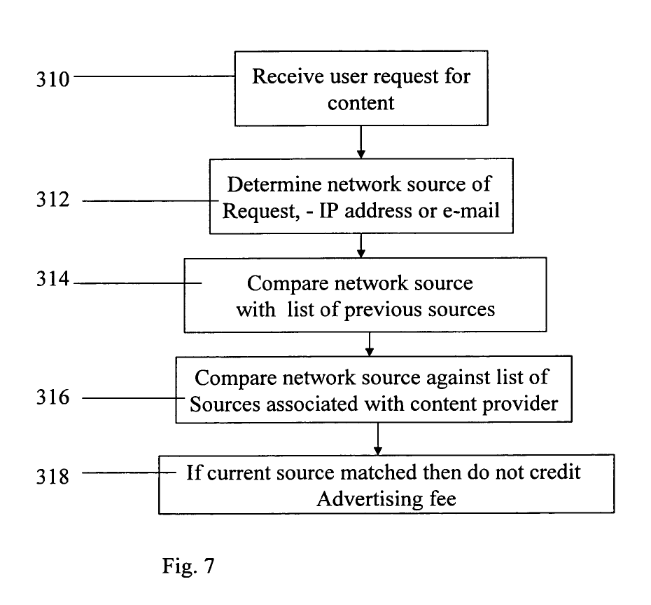

Reference is now made to FIG. 7, which is a simplified flow chart illustrating a method of screening out repeated requests from same network nodes, say web locations, so that such repeated requests do not lead to debiting and crediting operations. That is to say the advertiser does not wish to pay several times for the same user. Any request for a download has to reveal a node on the network to which the download is to be made. In the method of FIG. 7 a download request is received in stage 310. Subsequently, in stage 312 a source of the download request is determined. The request may for example have an e-mail address, an IP address, or a telephone number. In stage 314, the request is compared with previous requests. In stage 316 the address information may optionally be compared against nodes known to be associated with the content provider. If an address match is found from either stages 312 or 314, then stage 318 is operated and the advertising fee is not triggered. Whether the download is actually carried out is a decision that is left for the specific implementation. It is noted that simple use of IP addresses or the like is not likely to be sufficient since multiple users may share a single IP address or a single user may download multiple products in short succession. However it is possible to identify heavy activity from a single source indicating automated action, including multiple requests for a single product.

In all of the above embodiments, a stage of compiling statistics of users requesting the content can be prepared. The statistical database is related but not limited to user content playing activities such as: time of playing, network used for downloading, rate of playing recurrence and more. Various reports, making use of different categories, can be created based on the statistical database.

Statistics of user profiles may be used to target the advertising. Thus if the user is a 12 year old girl there is no point advertising a car.

One preferred embodiment counts the number of events of content playing and modifies the advertisement associated with the content when the number of events exceeds a pre-determined number. For that matter, several advertisement files are embedded into a single content file wherein only some of them are active at a given time when content is being played. The combined content advertisement file is capable of counting the number of times that the content is played and may automatically activate and de-activate embedded advertisements for playing. Thus after ten plays the advertisement may be exchanged with a new advertisement.

The usage reports may include who listened and what they listened to. They may also include location, say based on cellular network data or on an IP address. In the case of the cellular telephone the type of telephone may be reported.

The statistics may subsequently be provided to the advertising source so that they can judge the effectiveness of their advertising campaign. Likewise the statistics can be provided to the content providers, who may for example be interested in correlations between free distribution via the Internet and paid-for distribution via other sources.

As explained above, the term media content includes text, music, speech, combined speech and music, video, and computer games, as well as combinations of media types. Forms of delivery of the content include both streaming the content and delivery of the complete file prior to opening and playing.

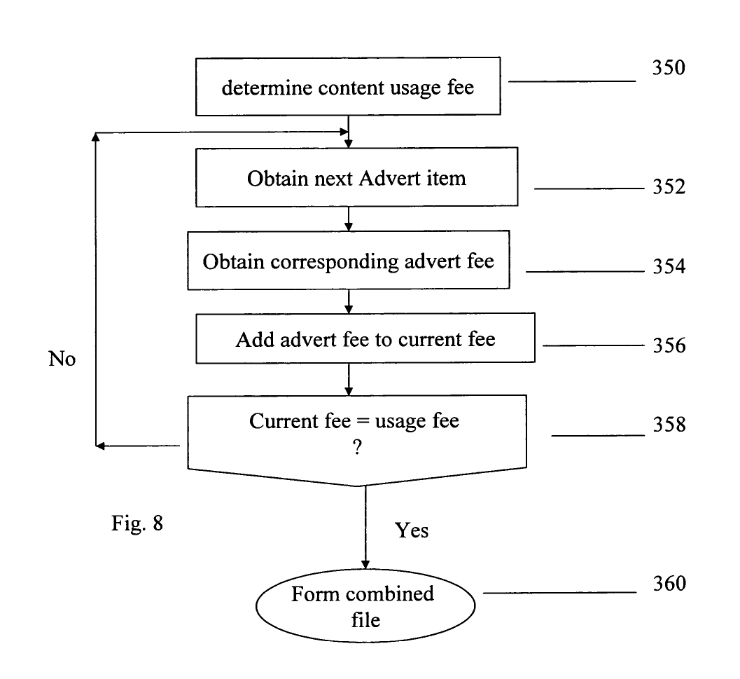

Reference is now made to FIG. 8, which is a simplified flow chart illustrating a method of providing multiple advertisements into a single media item in order to meet a specified distribution fee. It will be understood that the distribution rights for given media items are not all of the same value. New music is more expensive than old music. A current chart favorite is more expensive than a track from thirty years ago. Likewise the charge for an entire movie, should it ever be made available by this route, is likely to be higher than a single music track. In addition the same media may have different costs from different suppliers. The method of FIG. 8 determines the usage fee being asked for any given content item in a stage 350. In stage 352 a next advertisement item is obtained. The given advertisement item comes with a fee that the advertiser is prepared to pay, which is determined in stage 354. As the advert is added to the media item, advert fee is added to a current fee in stage 356. In stage 358 it is checked whether the current fee yet equals the usage fee determined in stage 350. If it does not then processing returns to stage 352 and adverts are continually added until the usage fee is equaled or exceeded.

Once the usage fee has been equaled or exceeded then the combined file is formed with all of the advertisements that have been added.

Whilst FIG. 8 deals with the specific case of a single purchased item having multiple advertisements to reach a given fee, it will be appreciated that slightly modified procedures may be developed by the person skilled in the art to provide a single advertisement for multiple media items or for one or a set of advertisements to appear in a set of media items, for example in a set of related music tracks sold as an album.

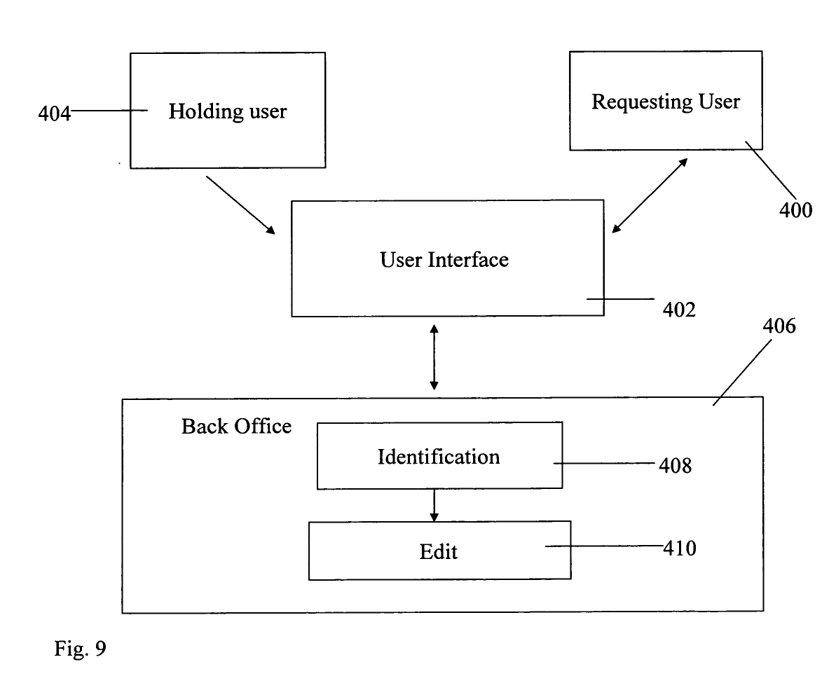

Reference is now made to FIG. 9, which is a simplified block diagram illustrating an adaptation of the present embodiments for file sharing. A requesting user interacts with a file-sharing interface 402 over a network such as the Internet to obtain content, which is held at holding user 404. The user interface 402 is effectively an online user's meeting place, which provides a list or more typically a search facility for finding given content and includes a method for automatic download.

The present embodiments provide a back office 406 which works with the user interface 402 to identify media sharing activities, decide whether the media being shared is part of its scope, and ensure that the rights are paid for. Thus the back office has first of all an identification unit 408, which identifies the media type. In one embodiment the identification unit obtains detail of the media such as artist, category and year. In another embodiment no such parameters are passed. The identification unit may also obtain data of who the content provider is and/or how to direct payment.

The output of the identification unit is then passed to an editing unit 410, which removes any old advertisement and adds one or more new advertisements in accordance with any of the embodiments above.

Special attention may be paid by the distributor to verify that the Digital Right Management (DRM) string embedded into the content file, which is used for controlling the access to the content file, does not deteriorate in any way the quality of content playing. A standard Digital Rights Management (DRM) string may be embedded into the combined content and advertisement file to support controlled sharing of the content files without causing any deterioration of the content file quality. Typically the DRM string allows the advertisements to be removed when they cease to be relevant. The DRM string may be extracted from the content file after a pre-defined number of times of content playing events or after a pre-defined length of elapsed time when access control becomes less of a critical issue, say a certain time after downloading. Removal of the DRM string may result in removal of the associated advertisements, leaving the content free, or it may result in cancellation of the content itself, as desired (limited distribution). The DRM string may also allow the content to be played a certain number of times first of all without advertising and only causing the advertising to play afterwards.

In one embodiment the user may choose the number of times he wishes to hear the advertisement or the amount of advertisements. In return, the more advertising he is prepared to accept the more or better quality content he receives.

In another embodiment, a commercially available content sharing application program such as ESNIPS may be used for downloading and sharing content files. All the distributed content files are downloaded through the application program which can keep track of the content and advertisement playing events and compile statistics of the age group of the sharing users.

In this embodiment the user may be able to enter into the distribution server and see which content files are available, yet downloading the content file is implemented only through the application program.

The user is enabled to build a content directory. At the level of the user community, users may mail each other one or more links of favorite content items. Sending may be through a forum, through chat, through WAP and other cellular sites.

The community members may communicate by email, chat, WAP and cellular networks or by other forms of data communication. The community may for example be location oriented and may distribute prizes to local community members. Alternatively, communities may be interest based or formed on any other basis.

The application program may generate recommendations regarding content files. The generator may be personalized so as to base the recommendations on personal preferences. The user preferences may be entered directly by the user or may be inferred, by keeping track of user activities and the user's recommendations to others regarding relevant content or merchandise.

Any other commercially available content sharing application program may be used for that matter. Pre-content, trailers and the like, may be distributed to entice users to obtain the full content.

Different kinds of content may be designated in different ways. Some content could be designated as free to everyone, or to designated users, or free for a certain amount of time, after which advertisements begin to appear. Certain content may be given out free more often than other content.

It will be appreciated that the embodiments cover the case of a plurality of advertisement content items from a single advertisement provider and using a plurality of advertisement content items from multiple advertisement providers. In either case a predetermined algorithm, of the kind discussed above in respect of FIG. 4, may be used to place different advertisements with different media content to form corresponding combined files.

Thus the present embodiments provide a targeted marketing strategy which enables effective targeting of audiences. In many ways the audiences identify themselves by expressing interest in the particular media items. Together with such intrinsic targeted marketing the embodiments stop the copyright infringements on content-based file sharing and downloads without trying to move against the tide of technological progress.

In the case of file sharing networks, individual downloads from one user to another over the network can be tracked, each giving rise to a separate advertising fee. The file-sharing network can carry out file combining at a central location, the network only allowing downloading of the combined files, or the combining can be carried out at each node of the network per download request, transparently of the node user. That is to say the node user receives a combined file which he views with the advertisement, but if another user requests a download of the file, the original uncombined media, is combined with a new advertisement. This latter embodiment is preferred since at the time of the later download, the original advertiser need not still be paying for additional advertising.

As explained, the result of the above is that content downloads can be offered free to end users, since the copyrights are paid for and sponsored by advertising.

The end users thus do not infringe any copyright laws, the content owners and publishers benefit from being paid for their content, thus returning their investment, and the advertiser reaches a wider and better targeted audience base than can be offered by television, on a much lower CPT expense.

The method may be used to offer the end users a catalog of content files to choose from, but the actual downloaded file contains the content combined with an advertisement file. The end user is exposed to the advertisement at least once when listening to, viewing the or otherwise using the content file for the first time. The advertisements can be attached to specific content or may be attached randomly, as discussed. In any case the end user is exposed to the marketing message at least once, turning the CPT investment into a useful application for those advertisers looking to maximum coverage based on varying scopes of audience parameters. The content owners and publishers, or any one acting on their behalf earns the money for the use of their copyright material. The end user has unlimited personal access and may download content free of charge and without breaking the law.

The transaction may be, but is not limited to the following:

1. The content owner and/or publisher distributors the content. In case the owner and the distributor do not represent the same corporation, the distributor typically buys the rights to distribute the content.

2. The payment made by the advertiser to either the content owner or the distributor or both parties is for media purchase: placing the advertisement file with the downloadable content file. The payment is similar to a payment made when buying media in any other platform: television, radio and newspaper. The advertiser can either supply the advertisement or ask the distributor to produce it for him.

3. The media owner (the distributor) and the content owner share the revenue, received for this transaction. The payment received for this transaction can be charged according, but not limited to, per download, per campaign, length of commercial, length of media spot, length of campaign (time-based), area of IP users receiving the commercial (local or international), type of content attached to the advertisement, etc.

4. The end user is given the right to access and freely download the content file from the designated site (HTTP, WAP, FTP, etc.).

The present method thus ensures that copyrights are fully or partly paid for by the media purchase done by the advertiser. The end user does not infringe any copyright laws and the advertiser obtains cheap but well targeted advertising. The embodiments additionally include a computer readable medium carrying code for the achievement of the above.

Using the above embodiments, a publisher is able to provide content for free, or collections of content for free and finance the content via advertising. Likewise an advertiser is able to provide the content or collections of content for free, and pay for his advertising by reimbursing the content right holders.

In addition the content can be provided free of advertising, in return for payment. In a preferred embodiment the payment is virtual payment.

The systems described above can be used with cellular telephony devices, so that content can be downloaded to the cellular devices.

Preferably content is provided that is suitable for all types of media and distribution. In particular with cellular telephony the content may need to be formatted for different kinds of telephones since different telephones have different capacities.

The system may be designed to provide the same user with content in other formats once purchased in a first format.

Advertising, as mentioned above, may be applied to content at a dedicated promotion server. Alternatively the advertising may be added by the publisher. Particular advertising campaigns or particular advertisements may be related to or attached to particular content items. The advertisements may be those of or associated with a particular company. Most usually the advertisements will be targeted at a particular audience.

The promotion server preferably runs a promotion platform. The platform may be provided to other sites as an affiliate program. This would provide an outlet for content and commercial activity through other peoples' sites. The positive attention, drawing of clicks, could be ascribed to the parent platform or to the affiliates as appropriate.

The same advertisement may be provided in one format or in many formats or file types, and in different types of media, for example audio, video, text etc.

The advertisement may be prepared as a number of content items which are integrally related to each other.

It is expected that during the life of this patent many relevant media files and content distribution systems will be developed and the scopes of the corresponding terms herein, particularly of the terms “media file” “content distribution” “network” and “file sharing”, are intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method of distributing content over a network comprising:
providing content file comprising media content from a content source;
providing a plurality of advertisement files comprising advertisement content from an advertisement provider;
combining said content file and said advertisement file into a combined file in playable format, configured such that only a fractional group of said plurality of advertisement files are playing when said combined file is playing and said fractional group changes automatically after a predetermined number of times of said combined file playing;
receiving requests from users for said content;
debiting said advertisement provider with an advertisement fee;
crediting said content source with said advertisement fee; and
downloading said combined file to requesting users for playing thereof.

2. The method of claim 1, wherein said debiting and said crediting are carried out per user request.

3. The method of claim 1, wherein said debiting and said crediting are carried out based on a global estimation of user requests.

4. The method of claim 1, further comprising screening out repeated requests from same network nodes.

5. The method of claim 1, further comprising compiling statistics of users requesting said content for providing to said advertising source.

6. The method of claim 1, wherein said providing a content file comprises providing multiple content files.

7. The method of claim 6, wherein said providing multiple content files comprises part of a file sharing arrangement.

8. The method of claim 1, wherein said media content is any one of a group comprising: text, music, speech, combined speech and music, video, and a computer game.

9. The method of claim 1, comprising having a plurality of advertisement content items from a single advertisement provider, and using a predetermined algorithm to place different ones-of said advertisement content items with said media content to form corresponding combined files.

10. The method of claim 1 comprising having a plurality of media items each requiring a different fee, and having a plurality of advertisement content items, and continuing to combine further advertisement content items with each respective media items to construct a corresponding combined file until a respective fee is covered.

11. The method of claim 1, comprising providing a plurality of advertisement content items from a plurality of advertisement providers, using a predetermined algorithm to place different ones of said advertisement content items from different advertisement providers to form corresponding combined files and debiting the respective advertisement provider.

12. The method of claim 1, wherein said network is a broadband network.

13. The method of claim 1, wherein said network is any one of a group comprising the Internet, an Interactive TV infrastructure and a cellular network.

14. A computer readable medium for use with a computer network for distributing content over the network, the distributing comprising:
providing a content file comprising media content from a content source;
providing a plurality of advertisement files comprising advertisement content from an advertisement provider,
combining said content file and said advertisement file into a combined file in playable format, configured such that only a fractional group of said plurality of advertisement files are playing when said combined file is playing and said fractional group changes automatically after a predetermined number of times of said combined file playing;
receiving requests from users for said content;
debiting said advertisement provider with an advertisement fee;
crediting said content source with said advertisement fee; and
downloading said combined file to requesting users for playing thereof.

15. The method of claim 1 comprising promoting distribution of a given content item by providing under predetermined conditions free content or content free of advertisement.

16. The method of claim 15 wherein said content free of advertisement is randomly distributed between a group of users, such that a randomly drawn user receives said content free of advertisement and remaining users receive said content with advertisement.

17. The method of claim 15, wherein said content free of advertisement is provided at a preselected time, content with advertisement being provided at other times.

18. The method of claim 15, wherein said content being promoted is newly introduced content.

19. The method of claim 1, wherein there is provided a content sharing application and wherein said content is downloaded and shared using said content sharing application program.

20. The method of claim 19, comprising building a content directory using said content sharing application program.

21. The method of claim 19 comprising compiling statistical data about said content and sharing said content, using said sharing application program.

22. The method of claim 1, comprising using a control string to control access to a given content file.

23. The method of claim 22, further comprising extracting said control string following fulfillment of a precondition, thereby to make said content freely available.

24. The method of claim 23, wherein said precondition comprises one member of the group consisting of:
a predefined number of playing events, and
a predefined length of time.

25. A method of distributing content over a network comprising:
providing content file comprising media content from a content source;
providing a plurality of advertisement files comprising advertisement content from an advertisement provider,
combining said content file and said advertisement file into a combined file in playable format,
receiving requests from users for said content;
debiting said advertisement provider with an advertisement fee;
crediting said content source with said advertisement fee; and
downloading said combined file to requesting users for playing thereof, wherein said downloading is carried out to a mobile telephony device.
